(19) United States
(12) Patent Application Publication
(10) Pub. No.: US 2024/0177038 A1
(43) Pub. Date: May 30, 2024

(54) Quantum Signal Processing Methods and Systems for Composite Quantum Gate Calibration

(71) Applicant: Google LLC, Mountain View, CA (US)

(72) Inventors: Yuezhen Niu, El Segundo, CA (US); Vadim Smelyanskiy, Mountain View, CA (US); Yulong Dong, Albany, CA (US)

(21) Appl. No.: 18/319,947

(22) Filed: May 18, 2023

Related U.S. Application Data
(60) Provisional application No. 63/344,284, filed on May 20, 2022.

(51) Int. Cl. G06N 10/20; G06N 10/40

(52) U.S. Cl. CPC G06N 10/20; G06N 10/40

(57) ABSTRACT

Methods for calibrating a quantum circuit including a tunable quantum gate and a composite quantum gate characterized by a set of gate parameters are disclosed. For each modulation angle of a set of modulation angles, the quantum circuit is operated on a qubit pair for a plurality of gate cycles by tuning the tunable quantum gate. Gate characterization data is generated based on measurements of the qubit pair. A first representation of a state-transition probability vector is determined for the qubit pair based on the gate characterization data. Values for the gate parameters are transformed into orthogonal bases of parameters and are determined independently from each other based on the set of coefficients and statistical estimators. The method significantly boosts the accuracy of gate parameter learning by providing such separation between parameters and thus reduces unwanted error from one gate parameter to the other.

### CROSS-REFERENCE TO RELATED APPLICATIONS

This application claims priority to U.S. Provisional Patent Application 63/344,284, entitled QUANTUM SIGNAL PROCESSING METHODS AND SYSTEMS FOR COMPOSITE QUANTUM GATE CALIBRATION, filed May 20, 2022, the contents of which are hereby incorporated by reference in its entirety.

### FIELD

The present disclosure relates generally to quantum computing systems, and more particularly to calibrating composite quantum gates (e.g., two-qubit quantum gates) in quantum computing systems.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b|1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a method for calibrating a quantum computing system used to operate a quantum circuit on a quantum system having a plurality of qubits. The quantum circuit may include a tunable quantum gate and a composite quantum gate. The composite gate may be characterized by a set of gate parameters. The method includes for each modulation angle of a set of modulation angles, operating the quantum circuit on a qubit pair of the plurality of qubits and for a plurality of gate cycles. For each of the plurality of gate cycles, the tunable quantum gate is tuned based on the modulation angle. Gate characterization data may be generated for the composite gate. Generating the gate characterization data may be based on obtaining, by one or more measurement devices, a measurement of a state of the qubit pair after implementing the quantum circuit for the plurality of gate cycles. A first representation of a state-transition probability vector may be determined for the qubit pair. Determining the first representation of the state-transition probability vector may be based on the gate characterization data. The first representation may be associated with a first vector space corresponding to the set of modulation angles. Values for the gate parameters of the set of gate parameters may be determined. Determination of the gate parameters may be based on the set of coefficients and one or more statistical estimators. The composite quantum gate may be calibrated and/or characterized based at least in part on the set of gate parameters.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure.

FIG. 2A depicts an example quantum circuit according to example embodiments of the present disclosure.

FIG. 2B provides pseudo-code for one non-limiting method of employing the quantum circuit of FIG. 2A to characterize and calibrate the fSim gate of FIG. 2A.

FIG. 2C provides a graphical schematic of a workflow for characterizing and calibrating a composite quantum gate that is consistent with the various embodiments.

FIG. 3A depicts a flow diagram of an example method for characterizing and calibrating a composite quantum gate according to example embodiments of the present disclosure.

FIG. 3B depicts a flow diagram of a method for acquiring quantum gate characterization data according to example embodiments of the present disclosure.

### DETAILED DESCRIPTION

Example aspects of the present disclosure are directed to enhanced systems and methods for calibrating composite quantum gates (e.g., two-qubit quantum gates) in a quantum computing system. Quantum gates can be the building blocks of quantum circuits implemented by quantum computing systems for quantum computation and quantum information processing. As used herein, the term “composite quantum gate” may refer to an object that performs operations on more than one input qubit (e.g., two qubits, three qubits). As used throughout, when discussing composite quantum gates, the terms “quantum gate” and simply “gate” may refer to a composite quantum gate. These two terms may additionally be employed to refer to single-qubit quantum gates (e.g., a quantum gate that performs operations on a single qubit). When distinction is required in the discussion, the terms composite gate and single-qubit gate may be employed. Various embodiments and physical implementations of composite quantum gates are discussed in Foxen B. et al., “Demonstrating a Continuous Set of Two-Qubit Gates for Near-Term Quantum Algorithms,” Phys. Rev. Lett. 125, 120504 (Sep. 15, 2020), the contents of which are incorporated in their entirety. This publication may be referred to as “Foxen” throughout.

Operation of a quantum computer can require characterization and calibration of experimentally realizable single-qubit and composite quantum gates. Robust and efficient quantum gate characterization provides information about the actualized quantum gates, which can then be used for the subsequent quantum control calibration in a quantum computing system. Quantum control calibration can include, for instance, calibration of control pulses to implement the quantum gates on a quantum system having a plurality of qubits. Quantum gate characterization and calibration are useful for achieving high-fidelity quantum computation and large-scale deployment.

One of the many challenges of realizing a practical quantum computation and information processing system is the isolation of the system's qubit wavefunctions from wavefunctions associated with elements outside the system (e.g., the rest of the universe). To perform quantum computation, two or more interacting qubits (e.g., that are being employed for computational purposes) should be isolated from their environment, including but not limited to other qubits in the system. This qubit isolation poses significant engineering challenges to quantum computation/information processing. When two or more interacting qubits are successfully isolated from the environment, the two or more qubits are said to be in “coherence”. Quantum computation/information processing may be possible by employing two or more coherent qubits.

An interaction between the environment and at least one of the qubits (e.g., of the two or more qubits employed for the computation) may lead to “decoherence” within the quantum computation system. Decoherence may result in the loss of computation and/or information processing ability within the system. Thus, quantum computation and information processing systems are limited by the timespan that coherence of the relevant qubits may be maintained by the system. More specifically, the ability to compute and/or process information in a quantum system is limited by the system's ability to maintain coherence, as compared to the runtime needed for the computation. As a rule of thumb, the runtime of the computation should be significantly less than the timespan that the system may maintain qubit coherence. The physical implementations of current and near-term quantum computation and information processing systems are associated with relatively finite runtimes. For these reasons, quantum computation and/or information processing may require characterization and calibration of the system's quantum gates to a sufficient accuracy and within a runtime that is commensurate with the system's ability to maintain qubit coherence.

The robustness of a quantum gate calibration protocol for a given gate may be characterized by its ability to determine a set of quantum gate parameters with high accuracy against other compounding imperfections, such as errors in the quantum state preparation and measurements. The efficiency of a calibration protocol may be measured by the total physical runtime for the calibration protocol to achieve a given accuracy. Given the stochastic nature of quantum measurements, the accuracy of a gate calibration protocol may be characterized by the variance of each gate parameter of the set of quantum gate parameters. Increasing the efficiency of the calibration of a gate may include decreasing a variance in the characterized set of parameters for a given runtime. Increasing the efficiency of the calibration of a gate may additionally and/or alternatively include decreasing the runtime required for a given variance in the characterized set of parameters. For reasons discussed above, successful realization of quantum computation may require characterization and calibration of quantum gates that is bounded by lower limit in accuracy (or alternatively an upper limit in variance, e.g., the variance in the parameters must be less than a variance threshold). The characterization and calibration may also be bounded by a lower limit in runtime (e.g., the determination of the parameters must be performed within a maximum runtime associated with the system's ability to maintain coherence).

Conventional methods of characterization and calibration of gates are limited by physical constraints (e.g., constraints relating to the Heisenberg Uncertainty Principle (UAP)) associated with the quantum measurements employed in the characterizations. These constraints may be referred to throughout as the “Heisenberg limit.” As such, these conventional methods achieve an accuracy on the order of 10⁻¹-10⁻² radii within a runtime that is commensurate with the ability of near-term quantum computational systems to maintain coherence. Given a limited mean coherence lifetime associated with current and near-term physical implementations of at least two coupled qubits, scalable and fault-tolerant quantum computation and/or information processing may require an accuracy on the order of 10⁻³-10⁻⁴ radii. That is, the upper variance bound (or threshold) of current and near-term systems is on the order of 10⁻³-10⁻⁴ radii. Accordingly, conventional methods of characterization and/or calibration may fall short in the required accuracy by two to three orders of magnitude in variance. An accuracy on the order of 10⁻³-10⁻⁴ radii (e.g., achievable within a runtime associated with current and near-term systems) is not only required for scalable and fault-tolerant computation/processing but is also important for benchmarking “crosstalk” between two or more qubits being processed within a composite gate. Although such crosstalk may be small in magnitude, without sufficient characterization, the crosstalk may detrimentally limit various quantum error detection and correction methods.

As described below, the enhanced embodiments discussed herein provide characterization and calibration of composite quantum gates that achieve an accuracy on the order of 10⁻³-10⁻⁴ radii, within a bounded runtime that is commensurate with current and near-term systems' ability to maintain coherence of their qubits. Accordingly, embodiments providing characterization and calibration of composite quantum gates may enable scalable and fault-tolerant quantum computation/information processing with sufficient error correction. As noted above, the conventional methods for the characterization and calibration of composite quantum gates may not enable scalable and fault-tolerant quantum computation/information processing with sufficient error correction. More colloquially, while the quantum measurement techniques employed by conventional gate characterization/calibration do not achieve the Heisenberg limit, the various embodiments (which employ separate and enhanced measurement methods) may achieve the Heisenberg limit.

More specifically, the embodiments provide a set of quantum metrology tools (e.g., systems and methods) for calibration protocols for characterizing and calibrating composite quantum gates (e.g., any two-qubit quantum gate). The embodiments achieve an accuracy that scales to and/or may achieve the Heisenberg limit and can be performed within runtimes that are commensurate with the longest runtime for each instance, e.g., longest circuit depth of, the current and near-term physical implementations of computation hardware. The embodiments include repeated (e.g., repeated in both the spatial and temporal domains) quantum measurements (e.g., measurements at the qubit level) that enable the determination of the set of quantum gate parameters characterizing a given composite quantum gate. Due to the repeated nature of the measurements, the determination of the set of gate parameters provides at least a quadratic improvement (over conventional methods) as a function of repetition in gate calibration. That is, the repetition in measurements enables the accuracy of the embodiments that scale better than alternative methods that suffer from time-dependent errors and decoherence. Furthermore, the embodiments are performed within sufficient runtimes. The alternative methods fail to achieve the Heisenberg limit, wherein various embodiments disclosed herein may achieve the Heisenberg limit. Accordingly, the embodiments enable practical quantum computation and quantum information processing, whereas conventional methods of gate characterization and calibration may not. Various details of the embodiments and implementations are discussed in conjunction with at least Dong Y. et al., “Beyond Heisenberg Limit Quantum Metrology Through Quantum Signal Processing,” (submitted on Sep. 22, 2022), https://arxiv.org/abs/2209.11207, the contents of which are herein incorporated in their entirety. This publication may be referred to as “Dong” throughout.

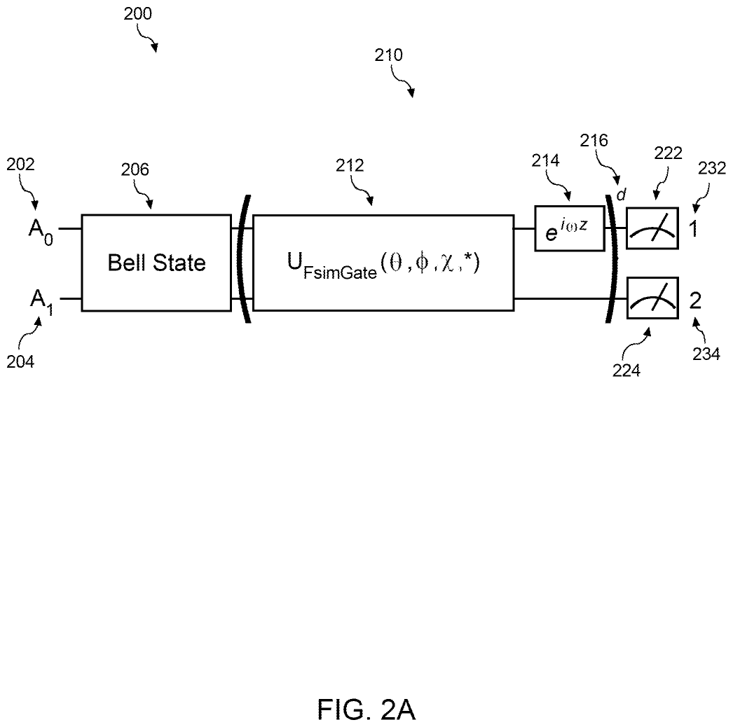

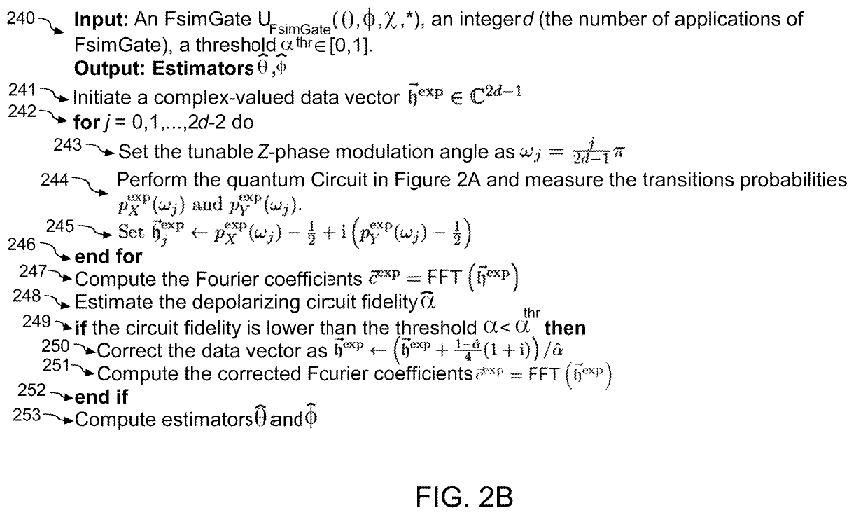

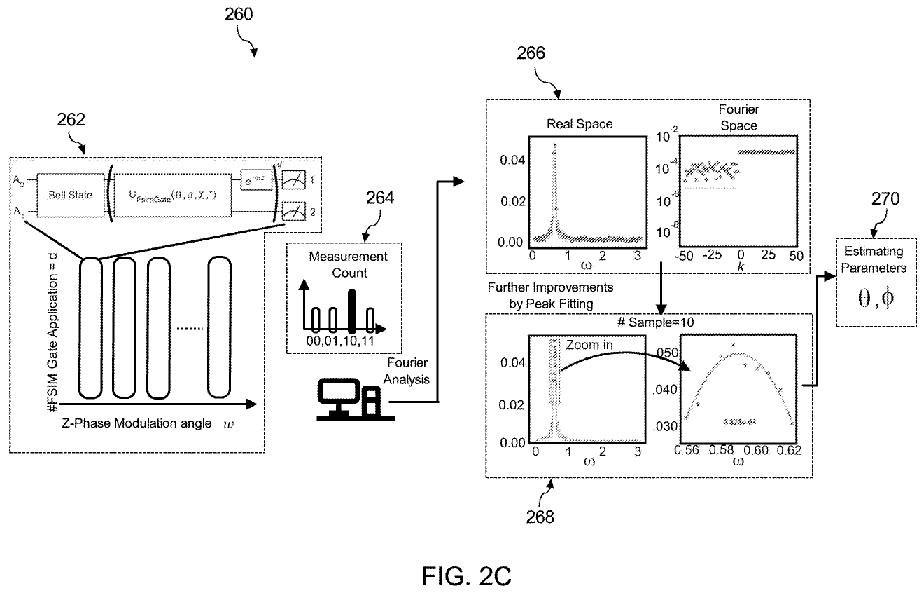

In some embodiments for characterizing and/or calibrating a composite quantum gate, a quantum circuit is employed. The quantum circuit may include the composite quantum gate and a single-qubit quantum gate. Various embodiments of the quantum gate are discussed in conjunction with at least FIG. 2A. However, briefly here, the composite gate may be a Fermionic Simulation (fSim) gate that operates on a first and a second qubit of a coupled qubit pair. As such, the fSim gate may be characterized by a set of gate parameters that includes a swap angle (θ) and a phase-shift angle (φ). The single-qubit gate may be a tunable Z-phase gate that operates on the first qubit. The quantum circuit may include a feedback loop with finite depth that corresponds to a depth of the calibration (indicated depth parameter represented by positive integer d). The feedback loop enables the quantum circuit to iteratively operate on the qubit pair for d iterations.

A set of Z-phase modulation angles is generated based on a depth parameter. Two state-transition probabilities scalars are measured for each modulation angle (e.g., ωⱼ, where the subscript j indicates an index addressing elements of the set). The first state-transition probability scalar (p_{X}(ωⱼ)) for the jth modulation angle indicates a probability for measuring the qubit pair, being initially prepared in a first Bell state:

$$\vert X 〉 ≡ ( \sqrt{\frac{1}{2}} ) ( \vert 01 〉 + \vert 10 〉 ) ,$$

and after d iterative operations of the quantum circuit on the qubit pair, being in the |10 [symbol] state. The second state-transition probability scalar (p_{Y}(ωⱼ)) for the jth modulation angle indicates a probability for measuring the qubit pair, being initially prepared in a second Bell state:

$$\vert Y 〉 ≡ ( \sqrt{\frac{1}{2}} ) ( \vert 01 〉 + i \vert 10 〉 )$$

and after d iterative operations of the quantum circuit on the qubit pair, being in the |10 [symbol] state.

In various embodiments, the two state-transition probabilities may be combined to generate a complex-valued vector: h_{d}(ωⱼ)≡(p_{X}(ωⱼ)−½)+i(p_{Y}(ωⱼ)−½), where the subscript d indicates the depth of the calibration. In the discussion herein, the complex-valued vector (h_{d}(ωⱼ)) may be referred to as a complex-valued probability vector. A set of expansion coefficients (or Fourier coefficients) may be generated based on a Fourier transform of the probability vector. The swap angle and the phase-shift angle may be estimated via statistical estimators. In various embodiments, the estimates for the set of gate parameters may be updated and/or improved upon by progressive differentiation, peak regression, and/or peak fitting methods.

Aspects of the present disclosure provide a number of technical effects and benefits. For instance, quantum computing systems and methods according to example aspects of the present disclosure can be used to calibrate and characterize composite quantum gates. The embodiments achieve an accuracy that scales better than alternative methods which may be prone to time-dependent errors and decoherence. Furthermore, the embodiments can be performed within runtimes that are commensurate with current and near-term physical implementations of computation hardware. More specifically, the embodiments provide characterization and calibration of composite quantum gates that achieve an accuracy on the order of 10⁻-10⁻⁴ radii, within a bounded runtime that is commensurate with current and near-term systems' ability to maintain coherence of their qubits. Accordingly, embodiments enable scalable and fault-tolerant quantum computation/information processing with sufficient error correction. As noted above, the conventional methods for the characterization and calibration of composite quantum gates may not enable scalable and fault-tolerant quantum computation/information processing with sufficient error correction and may fail to achieve the Heisenberg limit. In contrast, various embodiments disclosed herein may achieve the Heisenberg limit.

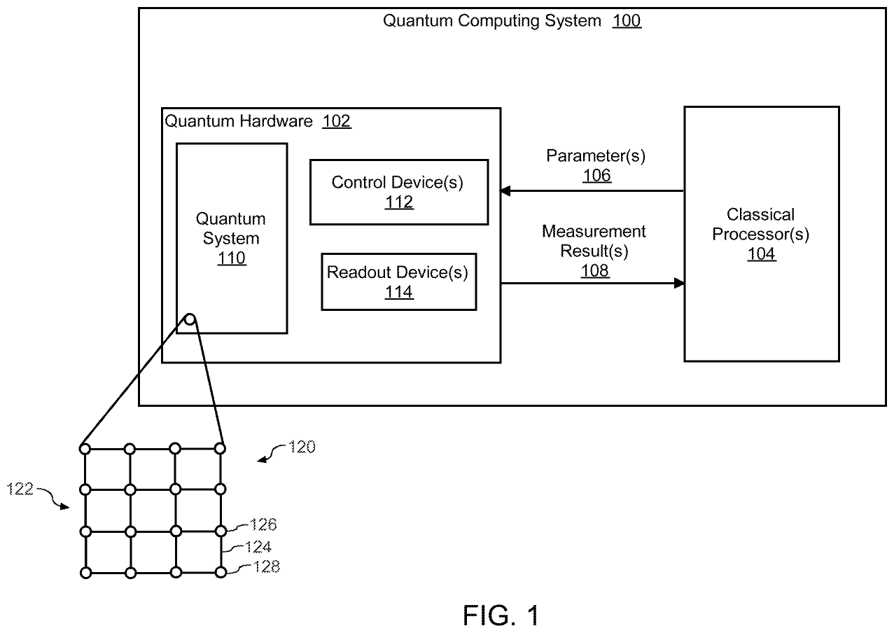

FIG. 1 depicts an example quantum computing system 100. The system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like.

The type of multi-level quantum subsystems that the system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit and the control device(s) 112 and readout devices(s) 114 may implement one or more quantum logic gates that operate on the quantum system 102 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of parameters 106.

In some implementations, the readout device(s) 114 can take advantage of a difference in the impedance for the |0 [symbol] and |1 [symbol] states of an element of the quantum system, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1 includes 4×4 qubits, however in some implementations the system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed.

FIG. 1 depicts one example quantum computing system that can be used to implement the methods and operations according to example aspects of the present disclosure. Other quantum computing systems can be used without deviating from the scope of the present disclosure.

FIG. 2A depicts an example quantum circuit 200 according to example embodiments of the present disclosure. For reasons discussed below, quantum circuit 200 may be referred to as a quantum signal processing calibration (QSPC) circuit. QSPC circuit 200 may be a composite circuit and include at least a first quantum gate 206, a second quantum gate 212, and a third quantum gate 214. The various embodiments may employ QSPC circuit 200 to determine a set of quantum gate parameters that characterize and/or calibrate second quantum gate 212. The QSPC circuit 200 is characterized by a depth parameter (e.g., d 216) that indicates a (circuit) depth of the characterization and/or calibration of the second quantum gate 212. The value of the depth parameter 216 is a positive integer. In various embodiments, the runtime of a characterization and/or calibration of the second quantum gate 212 may scale at least approximately linearly with the value of d 216. That is, the runtime of the characterization and/or calibration of the second quantum gate 212 may scale approximately as 0(d).

First quantum gate 206 and second quantum gate 212 may be 2-qubit gates (e.g., a composite gate), while third quantum gate 214 may be a single-qubit gate. Being a composite circuit, QSPC circuit 200 may perform operations on a pair of input qubits. The pair of input qubits may include a first qubit (A₀) 202 and a second qubit (A₁) 204. The first and second qubits 202/204 are coupled, such that a combined state-space for the pair is formed via the tensor product of their individual state spaces, e.g., {|0 [symbol] , |1 [symbol] }⊗{|0 [symbol] , |1 [symbol] }. Unless otherwise noted, the ordered 2-qubit basis: {|00 [symbol] , |01 [symbol] , |10 [symbol] , |11 [symbol] } will be employed to represent the state of the qubit pair, where the leftmost index in a 2-qubit ket (e.g., |00 [symbol] ) refers to the state of the first qubit (A₀) 202 and the rightmost index in the 2-qubit ket refers to the state of the second qubit (A₁) 204.

Upon operating on the pair of qubits, the QSPC circuit 200 may provide the pair of qubits as an output pair of qubits. A first measurement device 222 and a second measurement device 224 are shown in FIG. 2A. The first measurement device 222 is enabled to measure the state of the first qubit 202 (e.g., A₀|1 [symbol] 232) and the second measurement device 224 is enabled to measure the state of the second qubit 204 (e.g., A₁=|0 [symbol] 234). Note that via the postulates of quantum mechanics, the measurement of at least one of the first and second qubits 202/204 is inherently stochastic and depends on the superposition coefficients of the outputted pair.

The first gate 206 is enabled to prepare the input pair into one of two possible Bell states:

$$\vert X 〉 ≡ ( \sqrt{\frac{1}{2}} ) ( \vert 01 〉 + \vert 10 〉 ) and \vert Y 〉 ≡ ( \sqrt{\frac{1}{2}} ) ( \vert 01 〉 + i \vert 10 〉 ) .$$

The first gate 206 may prepare the input pair of qubits in one of the two possible Bell states in a stochastic manner. In at least one embodiment, each time a pair of input qubits is supplied to the input of the first gate 206, the first gate 206 may output either

$$\vert X 〉 ≡ ( \sqrt{\frac{1}{2}} ) ( \vert 01 〉 + \vert 10 〉 ) or \vert Y 〉 ≡ ( \sqrt{\frac{1}{2}} ) ( \vert 01 〉 + i \vert 10 〉 )$$

with equal probability. The Bell state (|X [symbol] or |Y [symbol] ) is provided to the input of the second gate 212.

The second gate 212 may be Fermionic Simulation (fSim) gate. fSim gate 212 may be characterized by a set of quantum gate parameters that includes at least a first gate parameter and a second gate parameter. The first and second gate parameters may be gate control angles. The first control angle may be referred to as the qubit swap angle (θ) and the second control angle may be referred to as the controlled phase shift angle (φ). In the various embodiments, the controlled phased shift angle (φ) may be interchangeably referred to as the single-qubit phase shift angle. Thus, the set of quantum gate parameters may be indicated as: {θ, φ}. Various embodiments and implementations of an fSim gate (e.g., fSim gate 212) are discussed in the Foxen publication. The various embodiments may employ QSPC circuit 200 to determine the set of quantum gate parameters: {θ, φ} for fSim gate 212 as discussed throughout.

In the ordered 2-qubit basis: {|00 [symbol] , |01 [symbol] , |10 [symbol] , |11 [symbol] }, the operations that fSim gate 212 performs on the input pair may be encoded in the matrix operator:

$$f Sim ( θ , φ , 𝒳 , ψ , ϕ ) = ( \begin{matrix}1 & 0 & 0 & 0 \\ 0 & ( {e}^{- i ( φ + ψ )} ) cos θ & - i ( {e}^{i ( χ - ψ )} ) sin θ & 0 \\ 0 & - i ( {e}^{- i ( 𝒳 + ψ )} ) sin θ & ( {e}^{i ( φ - ψ )} ) cos θ & 0 \\ 0 & 0 & 0 & {e}^{- i ( ϕ + 2 ψ )}\end{matrix} ) .$$

Accordingly, an application of the fSim gate 212 on an input qubit pair is to provide a relative rotation between the {|01 [symbol] , |10 [symbol] } components (based on the qubit swap angle (74 )) of the input pair and to introduce a phase shift angle (φ) in the {|01 [symbol] , |10 [symbol] } components of the input pair.

After the operations of the fSim gate 212, the first qubit 202 is provided to the third (e.g., single qubit) gate 214. The third gate 214 acts to introduce a Z-phase modulation angle (ω) into the first qubit 202, via the operation e^{iωZ}, where Z indicates the Pauli Z-matrix:

$$Z = {σ}_{Z} = ( \begin{matrix}1 & 0 \\ 0 & - 1\end{matrix} ) .$$

That is, the third gate 214 performs a rotation (e.g., dependent on the Z-phase modulation angle) around the Z-axis of the first qubit's 202 Bloch sphere representation. As such, the third gate 214 may be referred to as the Z-phase gate 214. The Z-phase gate 214 may be a tunable gate such that the modulation angle (ω) may be controllably tuned and/or adjusted. As discussed in conjunction with at least FIG. 2B, the value of the tunable Z-phase modulation angle may be controlled, updated, and/or adjusted for each of the iterations of the calibrations and/or characterization protocol.

The ordered gate combination of fSim gate 212 and the Z-phase gate 214 may be iteratively applied to the qubit pair multiple times based on the depth of the calibration (e.g., as indicated by the depth parameter 216). Although not shown explicitly in FIG. 2A, QSPC circuit 200 may include a finite feedback loop. The feedback loop may include d iterations. More particularly, the first qubit 202 signal line may be fed-back from the output of the Z-phase gate 214 and into the input of the fSim gate 212 a total of d times. Likewise, the second qubit 204 signal line may be fed-back from the output of the fSim gate 212 and back into the input of the fSim gate 212 a total of d times. The depth parameter (e.g., d 216) is shown as a superscript to the grouping of the fSim gate 212 and the Z-phase gate 214 to indicate the repeated and iterative application of the fSim gate 212 and the Z-phase gate 214 to the input qubit pair. The number of iterations through the circuits may be equivalent to the value of d 216, which is a positive integer. In various embodiments, the value of d 216 may be significantly greater than 1. After d 216 iterative operations of the fSim gate 212 (to both qubits of the pair) and the Z-phase gate 214 (e.g., to the first qubit 202), the first measurement device 222 may be employed to measure the state of the first qubit 202 (|A₀ [symbol] =|0 [symbol] or |1 [symbol] ) and the second measurement device 224 may be employed to determine the state of the second qubit 204 (|A₁ [symbol] =|0 [symbol] or |1 [symbol] ).

Turning attention to FIG. 2B, FIG. 2B provides pseudo-code 240 for one non-limiting method of employing the quantum circuit 200 of FIG. 2A to characterize and calibrate the fSim gate 212 of FIG. 2A. Various embodiments and implementation details are discussed in the Dong publication. However, briefly here, pseudo code 240 receives d 216 (e.g., the depth parameter that indicates the depth of the characterization/calibration protocol) as an input parameter. The output of pseudo-code includes the estimate (via statistical estimators) of the values of the set of quantum gate parameters for fSim gate 212, e.g., {θ, φ}. That is, execution of pseudo-code 240 determines estimates of the qubit swap angle (e.g., θ) and the single-qubit phase shift angle (or controlled phase shift angle, e.g., φ) for the fSim gate 212. Line 241 of pseudo-code 240 indicates an initialization of a complex-valued vector, with (2d−1) complex-valued (e.g., two real values that indicate a magnitude and a phase) components. For reasons discussed below, the vector (or 1D array) may be referred to as a complex-valued probability vector and may be indicated as \vec{h}^{exp}, (ωⱼ, d), or h_{d}(ωⱼ) interchangeably. Note that h_{d}(ωⱼ) (and h(ωⱼ, d)) may be employed to address and/or indicate the jth component of the probability vector. Line 242 initiates a for-loop that is closed at line 252. The integer index j is used as a depth counter for the for-loop bounded by lines 242 and 252. Thus, the integer-index j may be employed to index the components of h_{d}(ωⱼ). Note that there is a total of (2d−1) steps in the for loop. The jth iteration of the for-loop may compute the jth component of h_{d}(ωⱼ).

The line 243, the Z-phase modulation angle is set (or tuned) to

$${ω}_{j} = \frac{j \cdot π}{2 d - 1} .$$

The Z-phase modulation angle may be a discretized value for the tunable Z-phase gate 214 of FIG. 2A. Accordingly, a set of Z-phase modulation angles consists of a set of evenly spaced values of ωⱼ ranging from 0 to

$$\frac{( 2 d - 2 ) \cdot π}{( 2 d - 1 )} .$$

This set of Z-phase modulation angles may be referred to as the set of modulation angles. Line 244 indicates that operations equivalent to iterative operations of the QSPC circuit 212 of FIG. 2A are performed on a pair on input qubits to calculate transition probabilities (e.g., p_{X}(ωⱼ) and p_{Y}(ωⱼ)). Similar to the complex-valued probability vector h_{d}(ωⱼ), the transition probabilities may be vector (or 1D array) objects, where the components are functions of the discretized modulation angle ωⱼ. The first and second transition probabilities may be of the same dimensionality of the complex-valued probability vector, and thus each may include (2d−1) components. Each iteration of the for-loop may be employed to computed one of the components of each of the first and second transition probabilities.

More specifically, the Bell gate 206 of FIG. 2A may be employed to select and initially prepare the input qubit pair in one of the two possible Bell states:

$$\vert X 〉 ≡ ( \sqrt{\frac{1}{2}} ) ( \vert 01 〉 + \vert 10 〉 )$$

and

$$\vert Y 〉 ≡ ( \sqrt{\frac{1}{2}} ) ( \vert 01 〉 + i \vert 10 〉 ) .$$

As noted above, the selection of one of the two Bell states may be a random (or a pseudo-random) selection process with equal probabilities between the two possible states to prepare the input qubit pair (e.g., first qubit 202 and second qubit 204 of FIG. 2A). The fSim 212 and the Z-phase gate 214 are iteratively applied to the input qubit pair (e.g., for a total of d times via the finite feedback loop discussed in conjunction with FIG. 2A) and the state of the first qubit 202 and the state of the second qubit 204 are determined by the first measurement device 222 and the second measurement device 224 respectively.

A first transition probability (e.g., p_{X}(ωⱼ)) is calculated. The first transition probability may be the estimated probability for measuring the state |10 [symbol] (e.g., after d iterations of the QSPC circuit 200), when the initial preparation of the input qubit pair was set (e.g., stochastically selected by the Bell gate 206) to the first Bell state |X [symbol] . Similarly, a second transition probability (e.g., p_{Y}(ωⱼ)) is calculated. The second transition probability may be the estimated probability for measuring the state |10 [symbol] , when the initial preparation of the input qubit pair was set (e.g., stochastically selected by the Bell gate 206) to the second Bell state |Y [symbol] . Note that for each iteration of the for-loop (and thus for each modulation angle ωⱼ), line 244 may be repeated many times (e.g., 1000, 10000, or more) in order to achieve enough samples to estimate both first and second transition probabilities with enough statistical significance to achieve a sufficiently small variance in the estimation of the set of quantum gate parameters. Accordingly, pseudo-code 240 may include an implicit “inner” for-loop, encapsulating line 244, such that the estimation of both the first and second transition probabilities are statistically significant. This implicit inner for-loop may be iterated over a significant number of times (e.g., such as but not limited to 1000, 10000, or more times). For each iteration of the inner for-loop, the Bell gate 206 may make the random (or pseudo-random) selection of one of the two possible Bell states. The combination of the transition probabilities p_{X}(ωⱼ) and p_{Y}(ωⱼ) may be referred to as gate characterization data: (p_{X}(ωⱼ),p_{Y}(ωⱼ)). Accordingly, line 244 (including the implicit encapsulating for-loop) may be referred to as acquiring gate characterization data.

At line 245, each of the j components of the complex-valued probability vector (h_{d}(ωⱼ)) is calculated based on the corresponding components of the transition probabilities. In one non-limiting embodiment, the complex-valued probability vector may be calculated as: h_{d}(ωⱼ)≡(p_{X}(ωⱼ)−½)+i(p_{Y}(ωⱼ)−½). Line 246 indicates the closing of the for-loop.

At line 247, a set of Fourier coefficients is generated and/or determined for the probability vector. As shown in line 247, a Fast Fourier Transform (FFT) algorithm may be applied to the vector h_{d}(ωⱼ) to generate the set of Fourier coefficients. The cardinality of the set of Fourier coefficients may be d. Thus, the set of Fourier coefficients may be represented by a vector (or 1D array) with d components: cₖ=FFT(h_{d}(ωⱼ)), where k is an integer index ranging from 0 to d−1. The notation c for the coefficients is employed to indicate that the coefficients may be complex-valued coefficients. Lines 248-252 of pseudo-code 240 are directed towards corrections to the set of Fourier coefficients. These corrections are discussed in detail in the attached the Dong publication. At line 253, the values for the set of quantum gates parameters are determined via the statistical estimators:

$$\hat{θ} = \frac{1}{d} {\sum }_{k = 0}^{d - 1} \vert {c}_{k} \vert and \\ \hat{φ} = \frac{3 d}{4 ( {d}^{2} - 1 )} {\sum }_{k = 0}^{k = d - 2} ( 1 - ( {( \frac{k - \frac{( d - 2 )}{2}}{\frac{d}{2}} )}^{2} ) ) \times phase ( {c}_{k} \cdot {c}_{k + 1}^{*} ) .$$

In some embodiments, the estimates for the swap angle and the single-qubit phase shift (or controlled phase shift angle) may be updated and/or improved upon. One non-limiting embodiment for improving the estimates may be referred to as progressive differentiation (pd). In such progressive differentiation embodiments, the Z-phase modulation angle may be fixed at ω=\hat{φ}. Additional gate characterization data may be acquired (while varying the depth parameter) to generate the vector (or 1D array): {h_{d}(\hat{φ}), h_{d+2}(\hat{φ}), h_{d+4}(\hat{φ}), . . . , h_{3d}(\hat{φ})}. The swap angle estimate may be re-computed as:

$${\hat{θ}}_{pd} = \frac{3 ( d + 1 )}{4 ( {( {d}^{2} - 1 )}^{2} - 1 )} {\sum }_{k = 0}^{d - 1} ( 1 - ( {( \frac{k - \frac{( d - 1 )}{2}}{\frac{( d + 1 )}{2}} )}^{2} ) \times ( {h}_{d + 2 ( k + 1 )} ( \hat{φ} ) - {h}_{d + 2 k} ( \hat{φ} ) ) ) .$$

In other embodiments, a peak regression method may be employed to update (or improve) the estimates for the set of quantum gate parameters. In still other embodiments, a peak fitting method may be employed to update (or improve) the estimates for the set of quantum gate parameters. In such peak regression (pr) and peak fitting (pf) embodiments, rather than varying the depth parameter (e.g., as the progressive differentiation embodiments do), the number of fSim gate applications is fixed at d to acquire additional gate characterization data. In such embodiments, additional gate characterization data may be acquired by sampling the Z-phase modulation angles over the interval

$$[ \hat{φ} - \frac{π}{2 d} , \hat{φ} + \frac{1}{2 d} ]$$

while holding the depth parameter constant. The sampled data is employed to update the estimates for the set of quantum gate parameters {\hat{θ}ₚᵣ, \hat{φ}ₚᵣ} as follows. In peak regression embodiments, at least one of the estimators is re-computed as the maximized value of a likelihood function. In peak fitting embodiments, the sampled data may be employed to regress a curve (e.g., a conic section such as but not limited to parabola) that approximates the peak. If the location of the peak of the curve does not deviate largely from \hat{φ}, the swap angle estimate is set to

$${\hat{θ}}_{pr} = \frac{( value of the peak of the fitted curve )}{d} .$$

It is shown in the Dong publication that the two transition probabilities (p_{X}(ωⱼ), p_{Y}(ωⱼ)) are conjugating variables such that the two transition probabilities may be combined via the complex-valued function h_{d}(ωⱼ)≡(p_{X}(ωⱼ)−½)+i(p_{Y}(ωⱼ)−½). The Fourier series expansion of h_{d}(ωⱼ) may admit to a simple approximate form which contains information of the swap angle and the phase shift angle of the fSim gate 212. In contrast to conventional methods, the determination of the set of quantum gate parameters is decoupled via the Fourier series expansion. As noted in pseudo-code 240, h_{d}(ωⱼ) may sampled on (2d−1) equally spaced modulation phase angle bins. A complex vector cₖ for k=0, 1, 2, . . . d−1 is generated by applying an FFT to the sampled values of h_{d}(ωⱼ). The Fourier coefficients with negative indexes may be vetoed from the analysis to improve the accuracy of the estimations. Statistical estimators (e.g., {\hat{θ}, \hat{φ}}) may be employed to estimate the swap angle and the phase shift angle of the fSim gate. The statistical estimators may be determined by processing the amplitude and the phase of the Fourier coefficients respectively. As noted above, the swap angle is estimated by:

$$\hat{θ} = \frac{1}{d} {\sum }_{k = 0}^{d - 1} \vert {c}_{k} \vert ,$$

where |⋅| indicates the magnitude (or absolute value) of a complex value. The phase shift angle is estimated as:

$$\hat{φ} = \frac{3 d}{4 ( {d}^{2} - 1 )} {\sum }_{k = 0}^{k = d - 2} ( 1 - ( {( \frac{k - \frac{( d - 2 )}{2}}{\frac{d}{2}} )}^{2} ) ) \times phase ( {c}_{k} \cdot {c}_{k + 1}^{*} ) .$$

where phase(⋅) indicates taking the phase of a complex value and the asterisk (*) indicates taking the complex conjugate of the complex value. The Dong publication illustrates that the variance of \hat{θ} scales as

$$O ( \frac{1}{{d}^{2}} )$$

and the variance of \hat{φ} scales as

$$O ( \frac{1}{{d}^{4}} ) .$$

As discussed above, the embodiments (via repeated application of the QSPC circuit 200 of FIG. 2A and pseudo-code 240 of FIG. 2B), provide systems and methods for estimating the swap angle and the phase shift angle of a fSim gate (e.g., fSim gate 212 of FIG. 2B). With the assumption that the error in the estimation of the phase shift angle (e.g., \hat{φ}), the estimate for the swap angle (e.g., \hat{θ}) may be improved via progressive differentiation, peak regression, and/or peak fitting, in the neighborhood of the maximum magnitude of the complex-values probability vector |h(ωⱼ, d)|. In progressive differential embodiments, the phase modulation angle is held to a constant value of ω=\hat{φ} and additional data samples are acquired to generate the vector (or 1D array):

{h_{d}(\hat{φ}), h_{d+2}(\hat{φ}), h_{d+4}(\hat{φ}), . . . , h_{3d}(\hat{φ})}. The swap angle estimate may be re-computed as:

$${\hat{θ}}_{pd} = \frac{3 ( d + 1 )}{4 ( {( {d}^{2} - 1 )}^{2} - 1 )} {\sum }_{k = 0}^{d - 1} ( 1 - ( {( \frac{k - \frac{( d - 1 )}{2}}{\frac{( d + 1 )}{2}} )}^{2} ) \times ( {h}_{d + 2 ( k + 1 )} ( \hat{φ} ) - {h}_{d + 2 k} ( \hat{φ} ) ) ) .$$

The Dong publication demonstrates that this estimation has a small (and bounded) bias and its variance scales as

$$O ( \frac{1}{{d}^{3}} ) .$$

In peak regression embodiments, s Z-phase modulation angles are sampled over the interval

$$[ \hat{φ} - \frac{π}{2 d} , \hat{φ} + \frac{1}{2 d} ] .$$

The estimators {\hat{θ}ₚᵣ, \hat{φ}ₚᵣ} may be employed as minimizers of a non-linear regression method using a closed analytical form (e.g., given above and in the Dong publication). Also in the Dong publication, the variance of both estimators are shown to scale as

$$O ( \frac{1}{{d}^{2} s} ) .$$

In peak fitting embodiments, a curve (e.g., a parabola) is fitted to a peak of the complex-valued probability vector. By such a parabolic approximation, an inference of the estimators may be efficiently executed using a least square approximation, as contrasted with a non-linear minimization method of the peak regression embodiments.

Turning attention to FIG. 2C, FIG. 2C provides a graphical schematic of a workflow 360 for characterizing and calibrating a composite quantum gate that is consistent with the various embodiments. At step 262 of workflow 260, the gate characterization data is acquired via the quantum circuit 200 of FIG. 2A. As noted above, the gate characterization data may include (p_{X}(ωⱼ),p_{Y}(ωⱼ)). as a function of ω. The plot in step 262 indicates acquiring the gate characterization data as a function of a discretized binning of the modulation angle axis (e.g., the x-axis). Step 264 shows a plot of measuring the acquired counts of the various states: {|00 [symbol] , |01 [symbol] , |10 [symbol] , |11 [symbol] }, for a particular value of ωⱼ. The counts may be employed to determine (p_{X}(ωⱼ),p_{Y}(ωⱼ)). The complex-valued probability vector may be calculated from (p_{X}(ωⱼ),p_{Y}(ωⱼ)). An FFT is applied to the probability vector. The probability vector (as a function ω) is shown plotted in step 266, as well as the FFT of the probability vector (as a function of k). The Fourier coefficients for negative values of k (those coefficients on the left side of the plot) may be vetoed from the analysis. At step 268, a parabola is fitted to the peak of the amplitude of the probability vector. At step 270, the values for the swap angle and the phase shift angle are determined via the estimators discussed throughout.

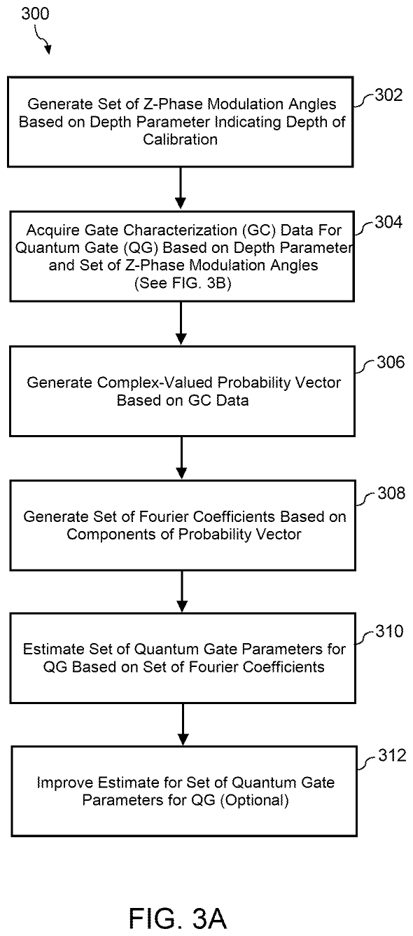

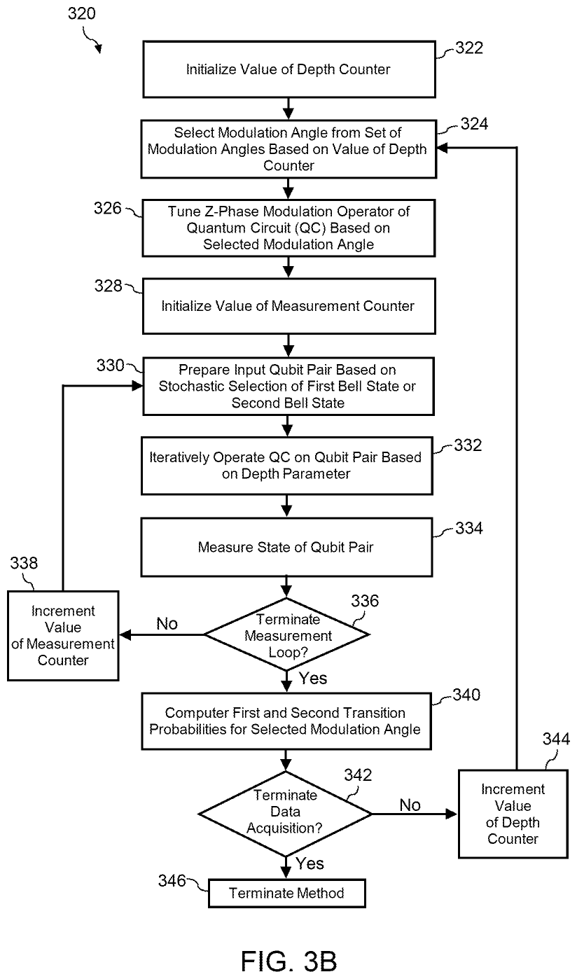

FIGS. 3A-3B depict operations performed in a particular order for purposes of illustration and discussion. Those of ordinary skill in the art, using the disclosures provided herein, will understand that operations of any of the methods described herein can be expanded, include steps not illustrated, omitted, rearranged, and/or modified in various ways without deviating from the scope of the present disclosure. Method 300 of FIG. 3A and method 320 of FIG. 3B may be implemented using any suitable quantum computing system, such as the system described in FIG. 1. Various portions of methods 300 and 320 may be implemented by one or more lines in pseudo-code 240 of FIG. 2B. As such, line numbers of pseudo-code 240 may be referred to in the following discussion. Methods 300 and 320 may include employing quantum circuit 200 of FIG. 2A to characterize and/or calibrate fSim gate 212 of FIG. 2A. As used herein, the term “computing devices” can refer to a classical computing device, quantum computing device, or combination of classical and quantum computing devices

FIG. 3A depicts a flow diagram of an example method 300 for characterizing and calibrating a composite quantum gate according to example embodiments of the present disclosure. Method 300 begins at block 302, where a set of Z-phase modulation angles is generated based on a value of depth parameters (d 216 of FIG. 2A) that indicates the circuit depth of the calibration. Line 243 of pseudo-code 240 indicates a calculation of the modulation angles of the set. At block 304, gate characterization (GC) data may be acquired. Various embodiments for acquiring GC data are discussed at least in conjunction with FIG. 3B. However, briefly here, the acquisition of GC data may be based on the depth parameter and the set of Z-phase modulation angles. Line 244 (including an implicit “inner” for-loop) of pseudo-code 240 may implement one non-limiting embodiment of acquiring GC data.

At block 306, a complex-valued probability vector may be generated based on the acquired GC data. Line 245 of pseudo-code 240 indicates a calculation of the complex-valued probability vector. At block 308, a set of Fourier coefficients is generated based on the complex values of the components of the probability vector. Line 247 of pseudo-code 240 indicates a calculation of the set of Fourier coefficients. At block 310, a set of quantum gate parameters are estimated for the quantum gate (e.g., fSim gate 212 of FIG. 2A) based on the set of Fourier coefficients. Line 253 of pseudo-code 240 indicates an estimate of the set of quantum gate parameters. At the optional block 312, the estimates for the set of quantum gate parameters may be updated and/or improved upon. The estimates for the set of quantum gate parameters may be updated and/or improved upon via the progressive differentiation, peak regressions, and/or peak fitting embodiments.

FIG. 3B depicts a flow diagram of a method for acquiring quantum gate characterization data according to example embodiments of the present disclosure. The “outer” loop indicated by blocks 324-344 of method 320 may be implemented by the for-loop of lines 242-252 of pseudo-code 240 of FIG. 2B. This outer loop may be referred to as the “depth” loop. The “inner” loop indicated by blocks 330-338 of method 320 may be implemented by implicit inner for-loop discussed in conjunction of line 244 of pseudo-code 240 of FIG. 2B. This inner loop may be referred to as the “measurement” loop. Method 320 may be initiated via a call from method 300 of FIG. 3A (e.g., from block 304 of method 300). Method 320 begins at block 322, where a value of a depth counter is initialized. In the context of pseudo-code 240, the depth counter may be indicated by the integer index j. At block 324, a modulation angle of the set of modulation angles is selected based on the value of the depth counter. Line 243 of pseudo-code 240 indicates a selection (or calculation) of the modulation angle. At block 324, the modulation angle of the Z-phase gate 214 of FIG. 2A may be tuned to the selected modulation angle. That is, the Z-phase operation of quantum circuit 200 of FIG. 2A may be tuned to the value of the selected modulation angle.

At block 328, a value of a measurement counter may be initialized. The measurement counter may be a counter index for the implicit inner for-loop discussed in conjunction with line 244 of pseudo-code 240. At block 330, an input qubit pair (e.g., first qubit 202 and second qubit 204 of FIG. 2A) may be prepared based on a stochastic selection of a first Bell state or a second Bell state. Block 330 may be implemented by the Bell gate 206 of FIG. 2A. At block 332, a quantum circuit (e.g., QSPC 200 of FIG. 2A) iteratively operates (e.g., for d iterations) on the qubit pair. At block 334, the state of each of the qubits in the qubit pair is measured. The first and second measurement devices 232/234 of FIG. 2A may be employed to measure the state of the qubit pair. At decision block 336, it is determined whether to terminate the “inner” measurement loop based on the value of the measurement counter. If the measurement loop is not to be terminated, method 320 flows to block 338, where the value of the measurement counter may be incremented. From block 338, method may return to block 330, where the input qubit pair is prepared in one of two possible Bell states. If the measurement loop is terminated, method 320 flows to block 340.

At block 340, first and second transition probabilities (e.g., p_{X}(ωⱼ) and p_{Y}(ωⱼ)) for the selected modulation angle are computed. At decision block 342, it is determined whether to terminate the “outer” depth loop based on the value of the depth counter. If the depth loop is not to be terminated, method 320 flows to block 344, where the value of the depth counter may be incremented. From block 344, method may return to block 324, where the next value of the modulation angle is selected. If the depth loop is to be terminated, method 320 flows to block 346, where method 320 is terminated and control may flow back to method 300 of FIG. 3A (e.g., control may flow to block 306 of method 300).

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits/qubit structures, or a combination of one or more of them. Alternatively, or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qubits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for characterizing a quantum circuit of a quantum computing system having a plurality of qubits, the quantum circuit comprising a tunable quantum gate and a composite quantum gate characterized by a set of gate parameters, the method comprising:
for each modulation angle of a set of modulation angles and for a plurality of cycles, operating the quantum circuit on a qubit pair of the plurality of qubits, wherein for each of the plurality of gate cycles, the tunable quantum gate is tuned based on the modulation angle;
generating gate characterization data for the composite gate based on obtaining, by one or more measurement devices, a measurement of a state of the qubit pair after implementing the quantum circuit for the plurality of gate cycles;
determining, by one or more computing devices, a first representation of a state-transition probability vector for the qubit pair based on the gate characterization data, wherein the first representation is associated with a first vector space corresponding to the set of modulation angles;
generating, by the one or more computing devices, a set of coefficients associated with a second representation of the state-transition probability vector, wherein the second representation is associated with a second vector space corresponding to a vector transformation; and
determining, by the one or more computing devices, at least one gate parameter of the set of gate parameters based on the set of coefficients and one or more statistical estimators.

2. The method of claim 1, further comprising:
calibrating, by the one or more computing devices, the composite quantum gate based at least in part on the set of gate parameters.

3. The method of claim 1, wherein obtaining, by the one or more computing devices, a measurement of the state of the qubit pair comprises:
obtaining a measurement of the state of the qubit pair for each of a plurality of measurement instances, wherein each measurement instance of the plurality of measurement instances is associated with a common number of gate cycles.

4. The method of claim 3, wherein a cardinality of the set of modulation angles, each modulation angle of the set of modulation angles, and a number of gate cycles of the plurality of gate cycles is based on a circuit depth associated with calibrating the quantum computing system.

5. The method of claim 1, wherein the qubit pair is an entangled qubit pair and the composite quantum gate implements a Fermionic Simulation (fSim) gate model that is operable on the entangled-qubit pair.

6. The method of claim 1, wherein the set of gate parameters includes a swap angle and a controlled phase angle for an ordered basis employable to represent states of the coupled-qubit pair.

7. The method of claim 1, wherein the tunable quantum gate is a single-qubit gate that operates on a first qubit of the qubit pair and the modulation angle indicates a rotation around a Z-axis of a Bloch sphere representation of the first qubit.

8. The method of claim 1, wherein the set of modulation angles represents a uniform discretization of Z-phase rotations of a first qubit of the qubit pair.

9. The method of claim 1, wherein the vector transformation is a Fast Fourier Transform.

10. The method of claim 1, wherein the first representation of the state-transition probability vector includes a number of components that have complex values, and the number of components of the probability vector is equivalent to a cardinality of the set of modulation angles.

11. The method of claim 1, further comprising:
for each modulation angle of the set of modulation angles, stochastically selecting one of a plurality of Bell states for a coupled two-qubit system;
for each modulation angle of the set of modulation angles, preparing the qubit pair in a stochastically selected Bell state of the plurality of Bell states; and
providing the qubit pair prepared in the stochastically selected Bell state to the quantum circuit.

12. A quantum computing system, comprising:
a qubit pair that includes a first qubit and a second qubit that is entangled with the first qubit;
a quantum circuit that includes a tunable quantum gate and a composite gate that is characterized by a set of gate parameters;
one or more processors;
one or more memory devices, the one or more memory devices storing computer-readable instructions that when executed by the one or more processors cause the one or more processors to perform operations for characterizing the composite gate, the operations comprising:
generating a set of modulation angles based on a depth of characterization of the composite gate;
acquiring characterization data by employing the quantum circuit to iteratively operate on the qubit pair, wherein the characterization data is a function of the modulation angles of the set of modulation angles;
generating a probability vector based on the gate characterization data, wherein the components of the probability vector have complex values and correspond to the set of modulation angles;
generating a set of Fourier coefficient based on the components of the probability vector; and
estimating one or more values for gate parameters of the set of gate parameters based on the set of Fourier coefficients.

13. The system of claim 12, wherein the operations further comprise:
calibrating the composite quantum gate for the quantum computing system based at least in part on the set of gate parameters.

14. The system of claim 12, wherein the operations further comprise:
updating the estimates of the one or more values for the gate parameters based on at least one of a progressive differentiation algorithm, a peak regression algorithm, or a peak fitting algorithm.

15. The system of claim 12 wherein the operations further comprise:
selecting a modulation angle from the set of modulation angles;
tuning the tunable quantum gate based on the selected modulation angle; and
acquiring a portion of the characterization data that is associated with the selected modulation angle by iteratively operating the tuned tunable quantum gate on the first qubit.

16. A method for characterizing a composite quantum included in a quantum circuit of a quantum computing system, the method comprising:
generating, by a computing system, a set of z-phase modulation angles based on a depth parameter;
acquiring, by the computing system, a set of characterization data for the composite quantum gate based on the set of z-phase modulation angles;
generating, by the computing system, a probability vector based on the set of characterization data for the composite quantum gate; and
calculating, by the computing system, estimates for a set of quantum gate parameters for the composite quantum gate based on the probability vector.

17. The method of claim 16, further comprising:
generating, by the computing system, a set of Fourier coefficients based on components of the probability vector; and
calculating, by the computing system, the estimates for the set of quantum gate parameters for the composite quantum gate based on the set of Fourier coefficients.

18. The method of claim 16, wherein acquiring the set of characterization data for the composite quantum gate comprises:
for each z-phase modulation angle of the set of z-phase modulation angles, stochastically selecting one of a plurality of Bell states for a qubit pair;
for each z-phase modulation angle of the set of z-phase modulation angles, preparing the qubit pair in a stochastically selected Bell state of the plurality of Bell states; and
for each z-phase modulation angle of the set of z-phase modulation angles, providing the qubit pair prepared in the stochastically selected Bell state to the quantum circuit.

19. The method of claim 18, wherein providing the qubit pair to the quantum circuit comprises:
iteratively operating the quantum circuit on the qubit pair; and
measuring a quantum state of the qubit pair; and
calculating one or more transition probabilities for the z-phase modulation angle.

20. The method of claim 16, wherein the set of gate parameters includes a swap angle and a controlled phase angle for an ordered basis employable to represent states of an entangled-qubit pair.
